(19) United States
(12) Patent Application Publication
(10) Pub. No.: US 2019/0059582 A1
(43) Pub. Date: Feb. 28, 2019

(54) APPARATUS FOR ADAPTING SLIDING CEILING LADDER RACKS FOR USE WITH MULTI-USE LADDERS

(71) Applicant: Rack Track, LLC, Wheaton, IL (US)

(72) Inventors: Eric T. Trusty, Wheaton, IL (US); Jason D. Trusty, Wheaton, IL (US)

(21) Appl. No.: 15/684,849

(22) Filed: Aug. 23, 2017

(51) Int. Cl. A47B 81/00; F16M 13/02; F16M 11/04; F16M 11/10

(52) U.S. Cl. CPC A47B 81/005; F16M 11/10; F16M 11/043; F16M 13/027

(57) ABSTRACT

An apparatus for adapting sliding ceiling ladder racks for multi-use ladders is disclosed. An example embodiment includes creating an adapter bracket, which can be attached to the functioning members of a sliding ceiling ladder rack with the adapter creating a self-restraining ladder mount specifically designed to accommodate and interact with the weight, form, and structure of most common multi-positional/multi-use ladders. The apparatus for adapting sliding ceiling ladder racks for multi-use ladders generally includes a parabolic rung support assembly with an upper and lower end, with the lower end being purposely curved upward to operably engage and capture the rungs of multi-use ladder and the upper end consisting of an upper mounting plate, which is pivotally connected to the lower parabolic support by means of a tensioned hinge.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2016-2017, Eric T. Trusty and Jason D. Trusty, All Rights Reserved.

### TECHNICAL FIELD

Embodiments of the disclosure relate generally to the field of sliding ladder rack adapter brackets and more specifically to an apparatus for adapting sliding ceiling ladder racks for multi-use ladders.

### BACKGROUND

Current sliding ladder racks are cumbersome to use, take up an excessive amount of space when not in use, and do not adapt easily to accommodate a variety of different multi-use ladders. Current sliding ceiling ladder racks also require additional means of providing tension or compression outside of the mounting brackets themselves and require additional adjustment for reliable fit for different multi-use ladders As a result, conventional sliding ladder racks cannot provide ideal support for multi-use ladders.

### SUMMARY

The disclosed embodiments relate generally to sliding ladder rack adapter brackets and more specifically to an apparatus for adapting sliding ceiling ladder racks for use with multi-use ladders. The disclosed example embodiments provide an adapter bracket, which can be attached to the functioning members of a sliding ceiling ladder rack with the adapter creating a self-restraining ladder mount specifically designed to accommodate and interact with the weight, form, and structure of most common multi-positional/multi-use ladders.

The disclosed embodiments generally relate to a sliding ladder rack adapter bracket, which includes a parabolic rung support assembly with an upper and lower end, with the lower end being a purposely curved upward so as to operably engage and capture the rungs of multi-use ladder and the upper end consisting of upper mounting plate, which is pivotally connected to the lower parabolic support by means of a tensioned hinge.

There has thus been outlined, rather broadly, some of the features of the disclosed embodiments in order that the detailed description thereof may be better understood, and in order that the present contribution to the art may be better appreciated. There are additional features of the disclosed embodiments that will be described hereinafter.

In this respect, before explaining at least one embodiment of the invention in detail, it is to be understood that the disclosed embodiments are not limited in its application to the details of construction or to the arrangements of the components set forth in the following description or illustrated in the drawings. The disclosed embodiments are capable of other embodiments and of being practiced and carried out in various ways. Also, it is to be understood that the phraseology and terminology employed herein are for the purpose of the description and should not be regarded as limiting.

An object is to provide an apparatus for adapting sliding ceiling ladder racks for use with multi-use ladders for creating an adapter bracket which can be attached to the functioning members of a sliding ceiling ladder rack with the adapter creating a self-restraining ladder mount specifically designed to accommodate and interact with the weight, form, and structure of most common multi-positional/multi-use ladders.

Another object is to provide an apparatus for adapting sliding ceiling ladder racks for use with multi-use ladders that significantly lowers the cost of manufacturing and simplifies installation by utilizing two identical adapters which may be mounted on either end of the ladder rack without regard to which end is the sliding portion or which end is fixed.

Another object is to provide an apparatus for adapting sliding ceiling ladder racks for use with multi-use ladders that utilizes one of two functionally identical hinged mounting brackets attached to the sliding end component of a sliding ceiling ladder rack.

Another object is to provide an apparatus for adapting sliding ceiling ladder racks for use with multi-use ladders that utilizes one of two functionally identical hinged mounting brackets which attaches to the fixed end component of a sliding ladder rack.

Another object is to provide an Apparatus For Adapting Sliding Ceiling Ladder Racks For Use With Multi-use Ladders that utilizes two identically constructed hinged mounting brackets which, thought identically constructed, each function in different ways due to their positioning in relation to the ladder on each end of the rack with the sliding end of the hinged mounting bracket limits hinging away from the fixed end while the adapter mounted to the fixed end may hinge upward and around the ladder rungs toward the sliding mount while resisting hinging away from sliding mount.

Another object is to provide an apparatus for adapting sliding ceiling ladder racks for use with multi-use ladders that has an curved mounting bracket/plate/surface below the hinge point that the ladder rungs rest into so as to have the weight of the ladder continuously draw the ladder's rungs downward toward the lowest and most central portion of the mounting bracket.

Another object is to provide an apparatus for adapting sliding ceiling ladder racks for use with multi-use ladders that significantly reduces manufacturing costs and simplifies installation because it does not require additional means of providing tension or adjustment to effectively secure the ladder in the mount with gravity, momentum, weight, and the structure of the ladder interacting together to allow the adapters to store and secure the ladder on the ceiling.

Another object is to provide an apparatus for adapting sliding ceiling ladder racks for use with multi-use ladders that significantly increases the available space below the rack when not in use, by hinging the brackets inward and upward toward the ceiling.

Another object is to provide an apparatus for adapting sliding ceiling ladder racks for use with multi-use ladders that prevents the ladder from swinging freely by limiting rotation of the mounting bracket the around the hinge point to one direction only to each toward the opposite mount.

Another object is to provide an apparatus for adapting sliding ceiling ladder racks for use with multi-use ladders that has a curved rung support with a preferred operating dimension which has a shape, radius, and size range which is ideally suited to support the ladder while stored and allows rotational movement around and within the closely spaced rungs of a multi-purpose ladder.

Other objects and advantages of the disclosed embodiments will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

The various embodiments are illustrated by way of example, and not by way of limitation, in the figures of the accompanying drawings. Various other objects, features and attendant advantages of the disclosed embodiments will become fully appreciated as the same becomes better understood when considered in conjunction with the accompanying drawings, in which like reference characters designate the same or similar parts throughout the several views, and wherein:

FIG. 1 is a lower perspective view of an example embodiment;

FIG. 2 is an upper perspective view of an example embodiment detailing the Parabolic Rung Support Assembly;

FIG. 3 is a front view of an example embodiment detailing the Parabolic Rung Support Assembly;

FIG. 4 is a side view of an example embodiment detailing the Parabolic Rung Support Assembly;

FIG. 5 is a side view of an example embodiment illustrating the relationship of a Multi-Use Ladder stored on the apparatus and how the Parabolic Plate pivots around the Lower Rung Section of a Multi-Use Ladder when a forwardly propelling force is induced upon the Multi-Use Ladder;

FIG. 6 is an end view of an example embodiment illustrating the Parabolic Rung Support Assembly holding the Lower Rung Section of a Multi-Use Ladder;

FIG. 7 is a lower perspective view of an example embodiment;

FIG. 8 is a side view of an example embodiment illustrating how the Top Rung Section seats into the Inner Surface of the Parabolic Plate during the loading process; and

FIG. 9 is a side view of an example embodiment illustrating how the Parabolic Plate of the Parabolic Rung Support Assembly may be hinged upward to save space beneath the unit while not in use.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

### Overview

Turning now descriptively to the drawings, in which similar reference characters denote similar elements throughout the several views, the figures illustrate an apparatus for adapting sliding ceiling ladder racks for use with multi-use ladders. An example embodiment includes creating an adapter bracket, which can be attached to the functioning members of a sliding ceiling ladder rack with the adapter creating a self-restraining ladder mount specifically designed to accommodate and interact with the weight, form, and structure of most common multi-positional/multi-use ladders. The apparatus for adapting sliding ceiling ladder racks for use with multi-use ladders generally includes a parabolic rung support assembly with an upper and lower end, with the lower end being purposely curved upward to operably engage and capture the rungs of multi-use ladder and the upper end consisting of an upper mounting plate, which is pivotally connected to the lower parabolic support by means of a tensioned hinge.

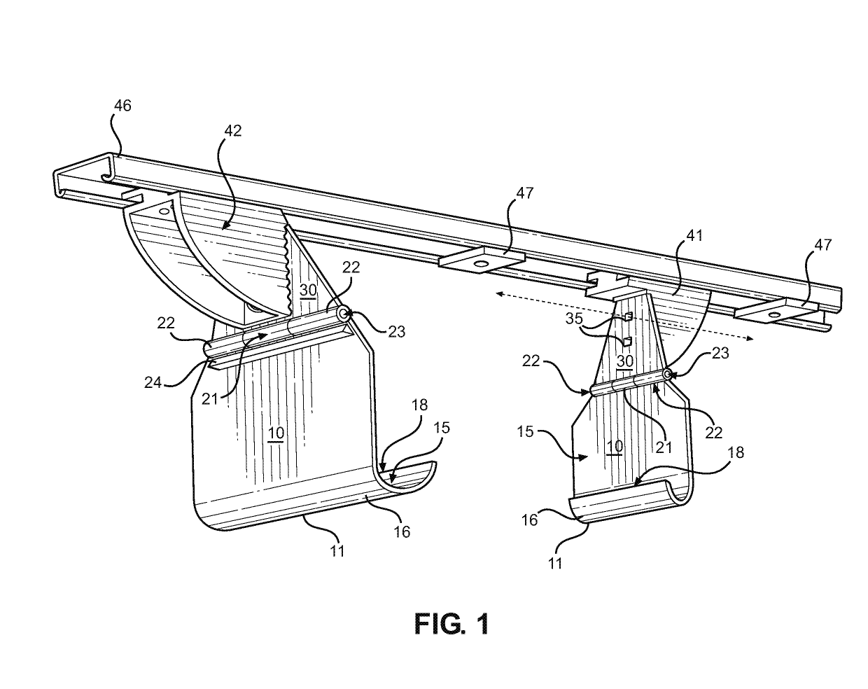

FIG. 1 is a lower perspective view of an example embodiment. Of the main components of the apparatus without a Multi-Use Ladder 50 installed onto one example of a Sliding Ceiling Ladder Rack 40. On the right side of the figure the Parabolic Rung Support Assembly 10 is inwardly facing and in position to engage with the top rung section 53 of a Multi-Use Ladder 50 Upper Mounting Plate 30 is mechanically connected to the Sliding Carriage Component 41 with fasteners that pass through the Fastener Holes 35 and into the Sliding Carriage Component 41 of a Sliding Ceiling Ladder Rack 40. On the Left Side of the image is the another Parabolic Rung Support Assembly 10 with Inner Surface 15 facing toward the opposing Parabolic Rung Support 10 and in position to engage with the Lower Rung Section 54 of a Multi-Use Ladder 50 It is attached to the Fixed Component 42 of a Sliding Ceiling Ladder Rack 40 which is mechanically connected by means of suitable fasteners which pass through the Fastener Holes 35 of the Upper Mounting Plate 30 and into the Fixed Component 42 of a Sliding Ceiling Ladder Rack 40. The Parabolic Plates 11 are shown in the fully extended, or lower-most position away from the ceiling.

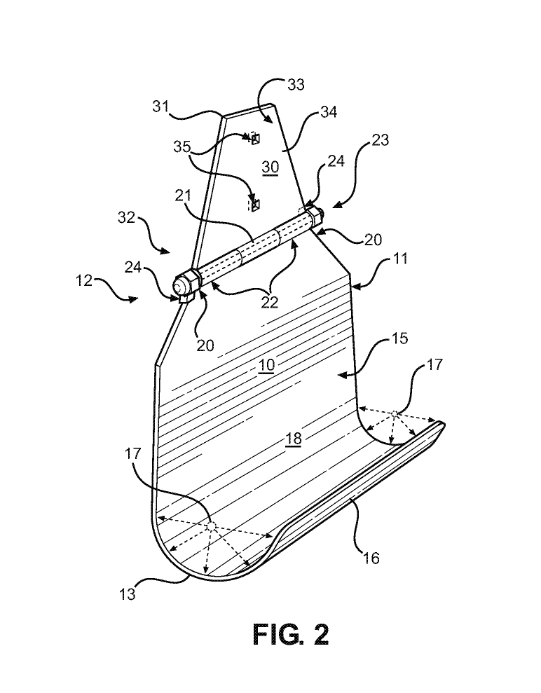

FIG. 2 is an upper perspective view of an example embodiment detailing the Parabolic Rung Support Assembly 10.

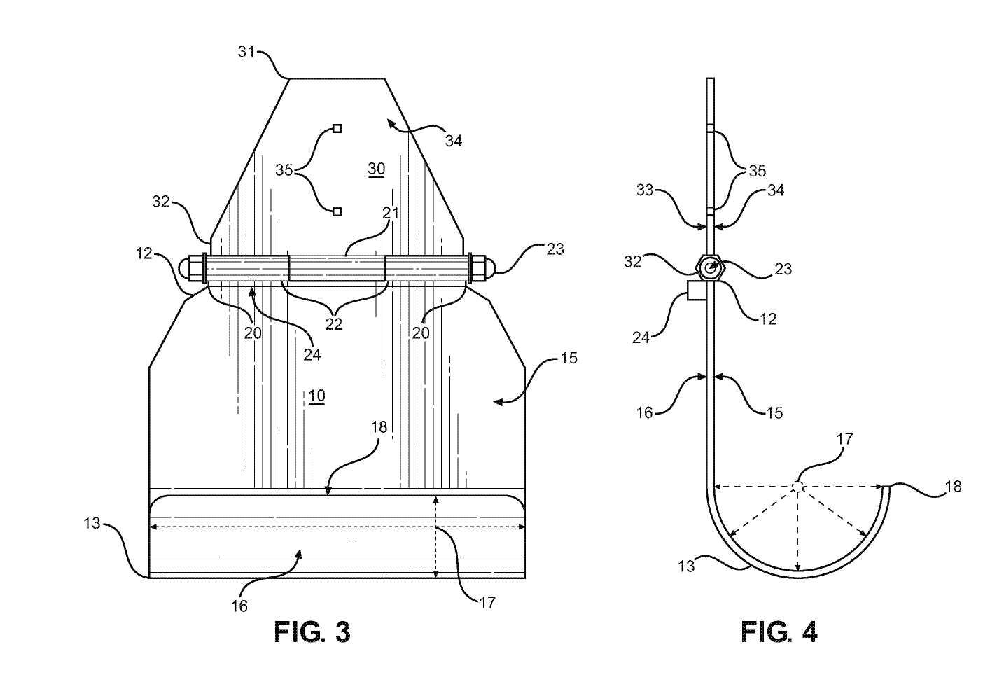

FIG. 3 is a front view of an example embodiment detailing the Parabolic Rung Support Assembly 10.

FIG. 4 is a side view of an example embodiment detailing the Parabolic Rung Support Assembly 10.

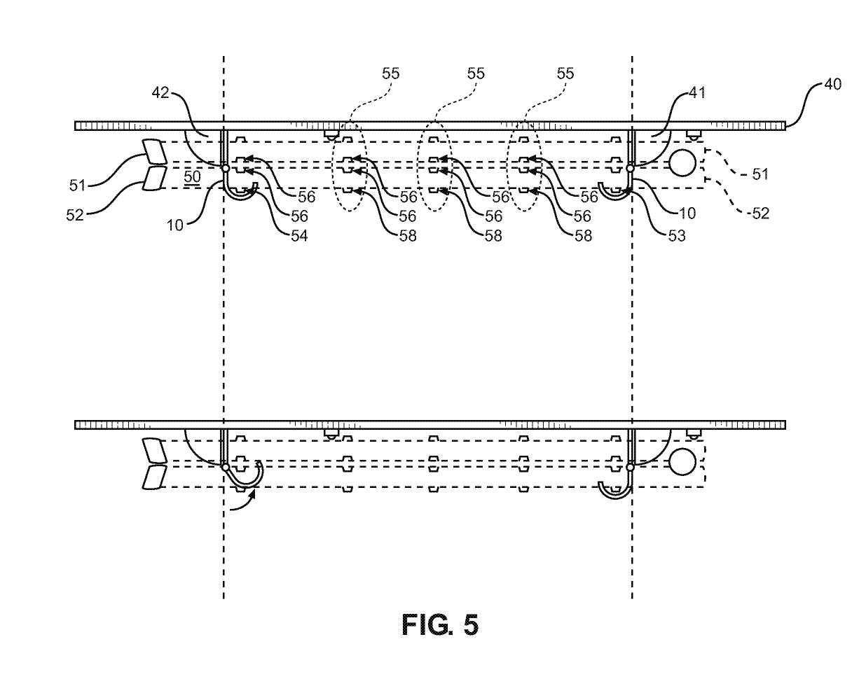

FIG. 5 is a side view of an example embodiment illustrating the relationship of a Multi-Use Ladder 50 stored on the apparatus and how the Parabolic Plates 11 pivot around the Lower Rung Section of a Multi-Use Ladder when a forwardly propelling force is induced upon the Multi-Use Ladder 50. The reference lines are included for positional reference.

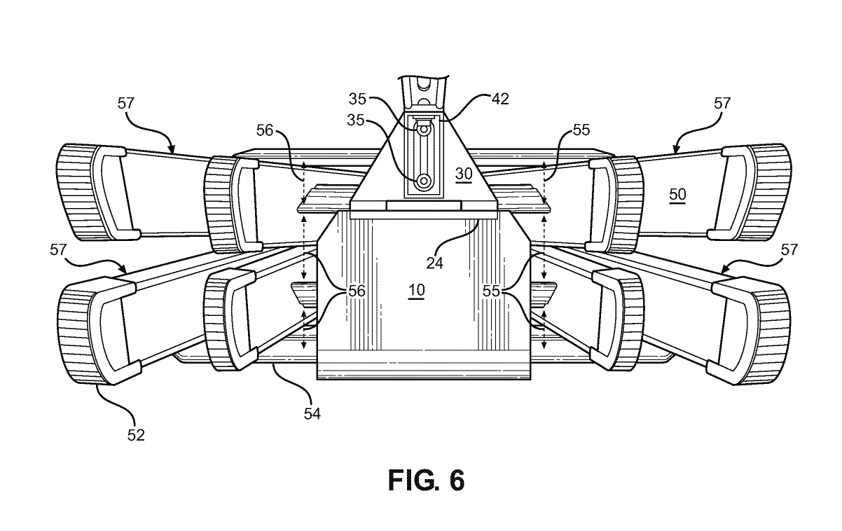

FIG. 6 is an end view of an example embodiment illustrating the Parabolic Rung Support Assembly 10 holding the Lower Rung Section 54 of a Multi-Use Ladder 50. The Compact Ladder Rung Configuration 55 and Space between Rung 56 is common in many Multi-Use Ladders 50 found on the market today. As shown, the Parabolic Plates 11 fit within the Side Rails 57 of a typical Multi-Use Ladder 50.

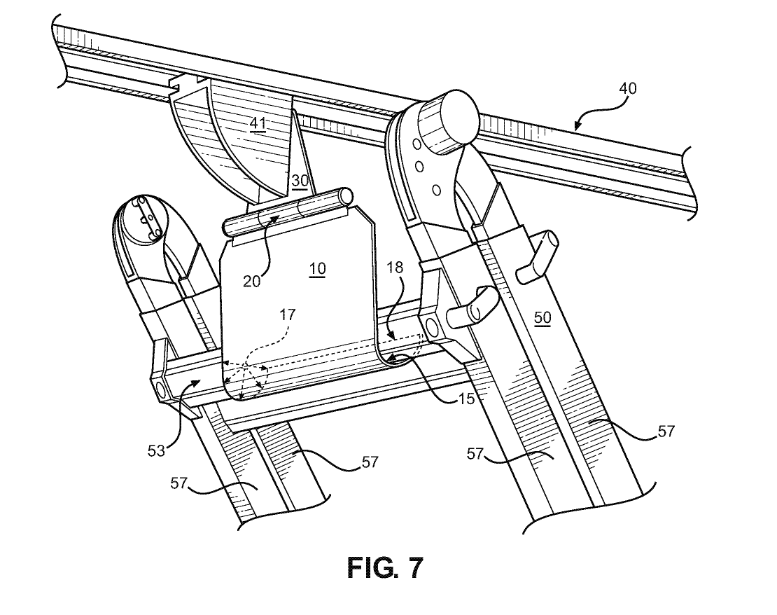

FIG. 7 is a lower perspective view of an example embodiment illustrating how the Top Rung Section 53 seats into the Inner Surface 15 of the Parabolic Plates 11 with the Leading Edge 18 of the Parabolic Plates 11 returning upward and around the rung and ending in a position within the Preferred Operating Dimension 17 required for the apparatus to interact with a Multi-Use Ladder 50.

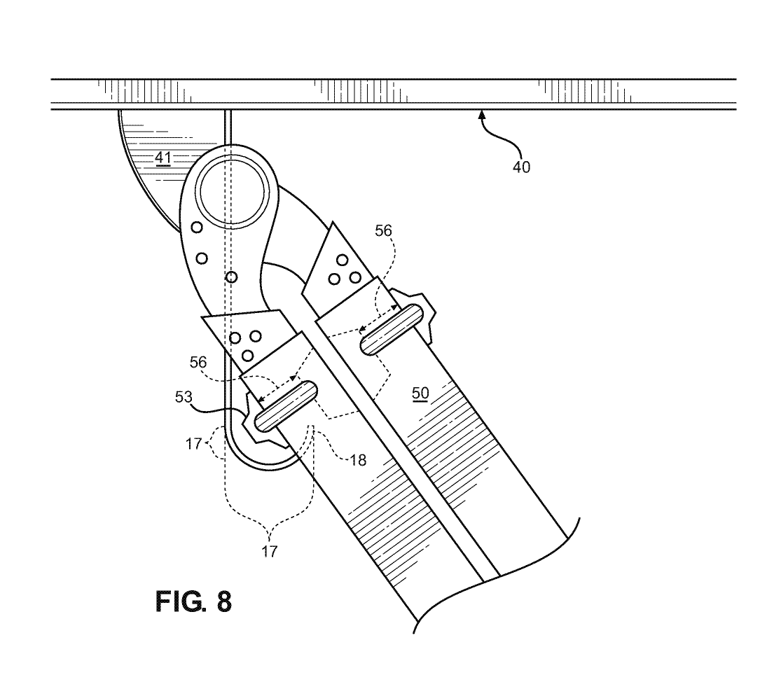

FIG. 8 is a side view of an example embodiment illustrating how the Top Rung Section 53 seats into the Inner Surface 15 of the Parabolic Plate 18 during the loading process.

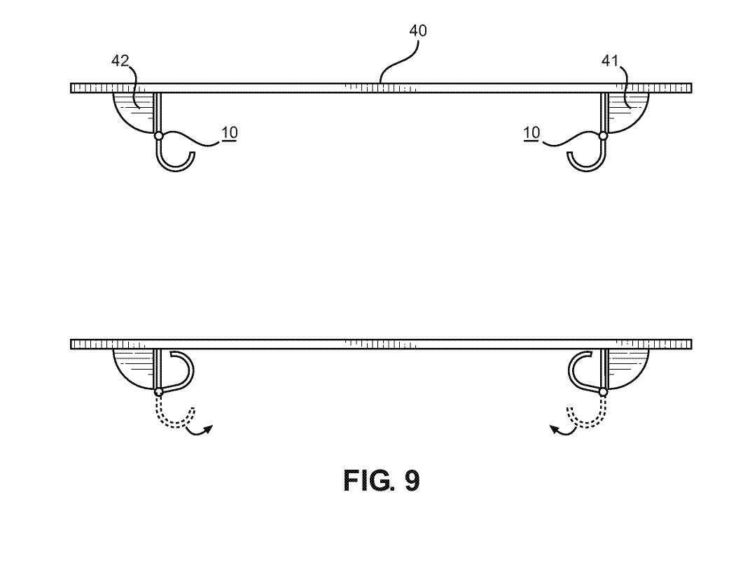

FIG. 9 is a side view of an example embodiment illustrating how the Parabolic Plates 11 of the Parabolic Rung Support Assembly 10 may be hinged upward to save space beneath the unit while not in use. The Tensioned Hinge 20 ensures that the Parabolic Plates 11 remain in the upward position without any additional fastening.

### INDEX OF ELEMENTS

10: Parabolic Rung Support Assembly
11: Parabolic Plate
12: Upper End
13: Lower End
14: Hinge Component
15: Inner Surface
16: Outer Surface
17: Preferred Operating Dimension
18: Leading Edge
20: Tensioned Hinge
21: Hinge Component From Upper Mounting Plate
22: Hinge Component From Lower Parabolic Support
23: Hinge Pin
24: Rotation Limiting Feature
30: Upper Mounting Plate
31: Upper End
32: Lower End
33: Mating Side
34: Exposed Side
35: Fastener Holes
40: Sliding Ceiling Ladder Rack
41: Sliding Component
42: Fixed Component
43: Means of Inducing Tension
44: Means of Compression
45: Means of Adjustment
46: Strut
47: Travel Stop
50: Multi-use Ladder
51: Upper End
52: Lower End
53: Top Rung Section
54: Lower Rung Section
55: Compact Ladder Rung Configuration
56: Space Between Rungs
57: Side Rails
58: Intermediate Rung Section

### Parabolic Rung Support Assembly

The parabolic rung support 10 is a curved structure preferably comprised of a plate structure with an upper end and a lower end. With the lower end specifically sized and shaped to fit between, under, and around the rungs of a multi-use ladder. The size and shape of this parabolic support is critical to the function of the apparatus as the support must fit between the rungs of a multi-use ladder and the curvature must such that it is both able to rotate around the rungs during loading and unloading cycle and additionally function in a way that allows the support to hinge upward to capture and retain the ladder when it experiences a sudden, forward-acting force as if the ladder is pushed forward from behind or an inertial force upon the ladder such as is experienced in a sudden stop in a vehicle. The curved structure of the parabolic support further functions to allow the weight of the ladder to naturally center the ladder rungs as deep as possible into the support to The parabolic support which aids in quieting the ladder within the apparatus as movement within the support is minimized to The parabolic support is mechanically connected by means of a tensioned hinge to the upper mounting plate which attaches to the sliding or fixed components of a sliding ceiling ladder rack.

The Parabolic Rung Support 10 of the apparatus is a critical component and one of three key main elements which work together to achieve the desired operating function of the apparatus when attached to a ceiling mounted sliding ladder rack. The Parabolic Plates 11 are a curved plate structure constructed of a material suitable for reliably holding the weight of a multi-purpose ladder, and which comes into contact with and holds the ladder rungs. It has an upper end 12 which is consists of a hinge component 21, and a lower end 13 which is curved into a parabolic shape with a Preferred Operating Dimension 17, which is allows a rotational movement of the Leading Edge 18 of the Parabolic Rung Support 10 around and within the closely spaced rungs of a multi-purpose Ladder. The Inner Surface 15 of this curved plate comes into contact with the ladder which rests under weight of gravity and due to the curved shape of the plate, the ladder is constantly urged by gravity toward the most central and lowest portion of the Inner Surface 15 the Parabolic Rung Support.

There are several known sliding ceiling ladder racks known in the ladder rack industry. These sliding ladder ceiling ladder racks are primarily utilized to store commonly used ladders on the inside of the vehicle on the ceiling. Typically, the sliding feature of the rack allows the user to manipulate the ladder on one end, significantly reducing the time and effort it would otherwise take to position a ladder in this way. The operation is straightforward and similar across the board for all known sliding ceiling ladder racks; the user places one end of a ladder on a sliding mount of any particular design; the user then slides the ladder forward and away; and then finally lifts the opposite end of the ladder into a final ‘stored’ position. Once in this ‘stored’ position, to ensure a proper and secure fit, these ladder racks typically require additional means of securement in the form of objects or devices that provide additional tension, compression, or lashing to retain the ladder and/or quiet and protect the ladder from vibrations during travel in various vehicles be they vans, truck caps, trailers or any similar vehicle suitable for carrying a ladder on the ceiling.

The Parabolic Rung Support is a key element in the disclosed apparatus which when combined with the other elements virtually eliminates the need for any additional securement and also allows the apparatus to be universal in its use on either the front of the sliding ceiling ladder rack or the back of a sliding ceiling ladder rack. Key in the parabolic/curved structure of the Parabolic Plates 11 is a Preferred Operating Dimension 17 curvature and shape, which could only be found through in depth and focused study of the structure of numerous multi-purpose ladders and factoring in the sliding and rotational motion necessary to facilitate the unique function of the apparatus.

The preferred radius of the curve of the Parabolic Plates 11 (the Preferred Operating Dimension 17) ranges between 0.75 inches and 3 inches (1.5 inch to 6 inch diameter). The preferred width of the Parabolic Plates 11, which engages with the ladder rung does not exceed 11 inches (the approximate width between the side rails of a multi-used ladder). The preferred operating depth ranges between 4.25 inches and 12 inches with 8.5 inches being the most common thickness of a multi-use ladder in the fully compact/closed position and 4.25 inches being the most common thickness of a multi-use ladder in the half-open/extended position.

The Parabolic Rung Support 10 disclosed is structured to achieve a very specific function and may only slightly vary without negatively affecting its intended function of interacting with the rungs of a multi-purpose ladder. Even so, it is entirely feasible that the parabolic rung support parabolic rung support could hold standard extension ladders, other A-Frame ladders, and other objects which may fit into the apparatus in a similar manner.

### Tensioned Hinge

The tensioned hinge 20 is located between the lower parabolic support and the upper mounting plate and functions as the pivoting attachment point between the two. As with most hinges, the structure consists of a plurality tubular, alternating, sections from both the upper mounting plate and the parabolic support. They are fixed into place by a hinge pin 23 which is structured so as to apply constant tension to the hinge point to eliminate free swinging of the support when not in use and yet still allow the parabolic support to be hinged upwardly each folding toward the center of the ladder rack by hand without the need for additional fastening of any kind. The hinge is also structured so as to limit hinge swing beyond 90 degrees (perpendicular to the ceiling). Limiting the hinge swing is a key function of the hinge as this allows the apparatus to have mount which remains fixed at the forward/moving end of the sliding ladder rack as the fixed/rear support is allowed to hinge forward when a forward acting force is applied to the ladder. Hinge tension adjustment points containing threads and nuts on each end of the hinge function to adjust tension in the event the hinge becomes too loose or too tight.

The Tensioned Hinge 20 is the rotational connection point between the Upper Mounting Plate 30 and the Parabolic Plates 11. The Tensioned Hinge 20 has a number of features which, when combined with the other main elements, achieve a unique multi-use ladder support, which is ideal for mounting and storing a multi-purpose ladder on a Sliding Ceiling Ladder Rack.

The Tensioned Hinge is preferably made of metal components similar to most high strength hinges however it may be constructed of high strength plastic material. The tension that keeps the hinge from freely swinging is preferably fixed and constant however it is obvious to that it may be may adjustable by means of a threaded hinge pin and nuts that hold the hinge in place on either side. Additional tension or resistance to hinging may be provided by means of chemicals or treatments that affect the hinges ability to swing freely, with little force required.

### Upper Mounting Plate

The upper mounting plate 30 is preferably a flat, metal, plate structure with an upper end and a lower end which is structured to contain hinge members that interlock with the hinge members of the parabolic support. Through the central portion of the upper mounting plate is a hole, slot, or series of holes and or slots which function to accept fasteners for mechanically attaching the apparatus to either the sliding or fixed members of a sliding ceiling ladder rack.

### Sliding Ceiling Ladder Rack

Sliding Ceiling Ladder Racks 40 have existed in the market for more than 15 years. Their purpose is to allow the user to place the ladder into the rack and store it for an indefinite period of time. Though these Sliding Ceiling Mounted Ladder Racks can be installed onto any ceiling location, it is known that most of these types of ladder racks are installed attached to the ceiling of a vehicle used to transport the ladder. Most typically the vehicle is a van or a pickup truck with a cap, or a trailer that is towed by another vehicle. All versions of these sliding ceiling ladder racks known to the inventor have adjustable parts and components which apply additional forces upon the system or the ladder to ensure that it remains sufficiently and safely secure within the sliding ceiling ladder rack. Examples of types of components used to apply these additional securing forces are shock cords (also known as bungee cords), gas, liquid, or mechanical springs, and other forms of cables, straps and tie methods common in the industry for securing a ladder in a vehicle.

It is the intention of the inventors, with the apparatus disclosed, to eliminate the need for these additional means of adjustment and securement, thereby improving on the manufacturing cost while also making the sliding ceiling ladder rack ideally suited for mounting and securing multi-purpose ladders. To the best knowledge of the inventors, there are no known sliding ceiling ladder racks, which specifically address the form and structure of multi-use, multi-purpose ladders.

The necessary components required for the apparatus to work on a Sliding Ceiling Ladder Rack 40 are a Strut 46 to which both a sliding component 41 and a fixed component 42 are attached (The strut itself attaches to the ceiling of a van, truck cap, or trailer). Fastener holes 35 are required to allow fasteners to pass through to couple the components of the apparatus to a Sliding Ceiling Ladder Rack 40

### Multi-Use Ladder

A Multi-Use Ladder 50, also known by some as a Convertible Ladder, is the generic term for a particular type of step ladder used by people to allow them to achieve a desired elevated position to achieve a task. The first known in the market was patented in the 1970s and has been built and marketed by many different manufacturers under several different brands including, but not limited to: LITTLE GIANT Ladders, GORILLA Ladders, WERNER Ladders, DARKHORSE Ladders, COSCO Ladders, KELLER Ladders, OXGORD Ladders, and XTREMEPOWERUS Ladders.

Multi-use ladders are unique from other standard step ladders and extension ladders in the way they can be variably extended, and articulated to achieve a wide variety of positions and lengths and yet can be collapsed into a relatively compact structure. Due to the features provided, Multi-use ladders have become the ladder of choice for many people who have the need for a ladder. Today, there are many brands of these ladders available in the market today. While they may vary in their precise build, most of these ladders in the market today share some common dimensional properties and structural elements upon which the disclosed apparatus relies. That is, 11″ of space between side rails and 8.5″ of depth in the most compact closed position, which includes 2″ of available space at the center through which the leading edge of the disclosed apparatus passes. It is important to note that it is not necessary to understand the mechanisms and how these multi-use, convertible ladders operate as it is inconsequential to the function of the apparatus. What is important and of chief consideration is that these multi-use, convertible ladders share the key structural elements and dimensional properties noted above that allow the apparatus as disclosed to accommodate and interact with all known multi-use ladders in the most compact and fully closed position. These similar elements and dimensions account for the Preferred Operating Dimension disclosed by the inventors that allows the apparatus to engage with the ladder in a very particular way during the mounting process as well as during extended periods of storage.

To summarize, the Parabolic Rung Support described herein is specifically sized, shaped and structured to achieve the best fit to achieve ideal loading, ideal storage, and containment of such multi-use, convertible ladders with a relatively minimal amount of parts to achieve the function of the apparatus. To that end, some of the key features of the disclosed apparatus are purposely sized, shaped, and structured to interact with the dimensional width, size, and spacing of the rungs, within the unique multi-tiered structure of a multi-use purpose ladder in its most compact and closed position.

### Operation of an Example Embodiment

APPARATUS LADDER LOADING OPERATION: Once the Parabolic Rung Support Assembly 10 is installed onto the Sliding Component 41 and Fixed Component 42 of a Sliding Ceiling Ladder Rack 40 the user physically lifts the ladder while grasping any suitable part of the Multi-Use Ladder 50, it is expected that the user would grasp an Intermediate Rung Section 58 or Side Rails 57. The User then lifts the Multi-Use Ladder 50 and directs the Top Rung Section 53 over the Leading Edge 18 and onto the curved Inner Surface 15 of the Parabolic Plates 11. The user then allows the weight of the Multi-Use Ladder 50 to rest into the engaging portion of the Top Rung Section 53 into the Lower End 13 of the Parabolic Plates 11.

With the Upper End 51 of the Multi-Use Ladder 50 now supported, the user may then grasp the Lower End 52 of the Multi-Use Ladder 50 and begin to push the ladder forward as the Parabolic Rung Support Assembly 10 is attached to the Sliding Component 41 of the Sliding Ceiling Ladder Rack 40 which is slideably attached to the Strut 46. The user continues to push the ladder forward until the Lower Rung Section 54 is clear of the opposing Parabolic Rung Support Assembly 10 that is extended and ready to receive the Lower Rung Section of the Multi Use Ladder 50. Once clear, the user lifts the ladder sufficiently to allow the entire Compact Rung Configuration 55 to clear the Leading Edge 18 of the Parabolic Plates 11 the user then reverses the travel of the Multi-Use Ladder 50 by pulling toward them and against the opposing Inner Surface 15 of the Parabolic Plates 11 of the Parabolic Rung Support Assembly 10. The user then allows the weight of the ladder to rest into the Lower End 13 of the Parabolic Plates 11. The user releases the ladder and it is now stored.

OPERATION OF THE APPRATUS DURING TRAVEL: It is important to note that the apparatus is intended to be installed onto the ceiling in cargo areas of vehicles such found in vans, truck caps, trailers, and the like. It is also known that during travel the ladder will experience inertial forces in every direction. The force of greatest concern is sudden deceleration during a hard-braking maneuver or other sudden stop due to an impact. During such a sudden stop, the entire Multi-Use Ladder 50 experiences a forwardly propelling inertial force and immediately urges the Top Rung Section 53 into the Parabolic Rung Support Assembly 10 associated with the Sliding Component 41 of the Sliding Ceiling Ladder Rack 40 The Rotation Limiting Feature 24 of the Tensioned Hinge 20 ensures that the Parabolic Plates 11 associated with the Sliding Component 41 cannot hinge forward and away from the opposing Parabolic Rung Support Assembly 10, which is engaged with the Lower End 52 of a Multi-use Ladder 50 beyond its most perpendicular position below the Strut 46. At the very same inertial moment, the Parabolic Plates 11 associated with the Fixed Component 42 of the Sliding Ceiling Ladder Rack 50, are urged immediately by the Lower Rung Section 54 of the Multi-Use Ladder 50, and begins to hinge forward and around the rotational axis of the Tensioned Hinge 20 while also rotating upward toward the Strut 46. As the Leading Edge 18 of the Parabolic Plates 11 swings around the rung in a manner which is only allowed by adherence to the Preferred Operating Dimension 17 that allows the Leading Edge 18 to sufficiently clear the structure of the Compact Rung Configuration 55 and pass into the space between rungs 56. The ladder will continue to hinge forward and upward until the ladder impacts the Strut 46 safely restraining the Multi-use Ladder 50 within the Apparatus that now holds the Multi-use Ladder 50 captive on all sides. As the forward propelling inertial force eases, the Multi-Use Ladder 50 then begins to drop to return to its original position under influence of gravity. As this happens, the curved Inner Surface 15 of the Parabolic Plates 11 continues to hold the ladder captive as the Leading Edge 18 exits the space between the Compact Ladder Rung Configuration 55. And slides around the Lower Rung Section 54 until the Rotation Limiting Feature 24 of the Tensioned Hinge 20 resists further backward travel beyond perpendicular away from the opposing Parabolic Plates 11. Once all forces imposed upon the ladder and the apparatus cease, the Multi-Use Ladder 50 comes to rest, settled into the Apparatus in its original, at-rest position. For illustrative understanding, it may be helpful to note that this entire operational process occurs very quickly, and would typically encompass a time period of no more than the two or three seconds that would be considered typical during any typical deceleration, sudden stop or impact situation.

APPARATUS LADDER UNLOADING OPERATION: The Unloading of the Ladder is, action for action, a reversal of the ladder loading operation previously detailed: The user grasps the Lower End 52 of the Multi-Use Ladder 50 and lifts it upward sufficiently to clear the Leading Edge 18 of the Parabolic Plates 11 associated with Fixed Component 42 of the Sliding Ceiling Ladder Rack 40. Once clear, the user then urges the Multi-Use Ladder 50 forward into the Top Rung Section 53 of the Parabolic Plates 11 associated with the Sliding Component 41 of the Sliding Ceiling Ladder Rack 40. As this is happening, the Rotation Limiting Feature 24 of Tensioned Hinge 20 resists hinging beyond a perpendicular position (90 degrees) in relation to the Strut 46. The user continues to push the ladder forward until the Lower Rung Section 54 is sufficiently clear of the Leading Edge 18 of the Parabolic Plates 11, enough so that it the Lower End 52 of the Multi-Use Ladder 50 may be lowered by the user. Once the entire Compact Rung Configuration 55 is clearly below the Parabolic Plates 11 associated with the Fixed Component 42 of the Sliding Ceiling Ladder Rack 40, the user then allows the weight of the ladder to be pulled toward the user as the Top Rung Section 53 is resting on the Inner Surface 15 and into the Lower End 13 of the Parabolic Plates 11 associated with the Sliding Component 41. As this occurs, the Parabolic Plates 11 are allowed to hinge toward the user as it is unrestricted in hinging in this direction. This hinging action serves to further ease and lead the Sliding Component 41 along the Strut 46 toward the user. The user continues to pull and lower the Multi-Use Ladder 50 until it reaches a point where it may then be lifted upward by the user so that the Top Rung Section 53 clears the Leading Edge 18 of the Parabolic Plates 11 and the user can then direct the Multi Use Ladder 50 away from the Parabolic Plates 11. Once this is done, the Multi-Use Ladder 50 is disengaged with the apparatus.

APPARATUS FOLDING and UNFOLDING OPERATION: While not in use, each of the Parabolic Plates 11 may be folded inwardly and upwardly toward the ceiling allowing the apparatus as a whole to take up considerably less space. The Tensioned Hinge 20 allows the user to grasp any part of the Parabolic Plates 11, preferably by applying force to the Outer Surface 16 and urging the Parabolic Plates 11 so that they may rotate upward. The Tensioned Hinge 20 is intended to resist typical forces of gravity and driving conditions and remain in this stored position until the user wishes to mount the Multi-Use Ladder 50 once again. To prepare the Apparatus for loading, the user simply grasps the Parabolic Plates 11 and pulls downward until it reaches its most perpendicular position in relation to the Strut 46. The Rotation Limiting Element 24 of the Tensioned Hinge 20 ensures that the hinge does not inadvertently swing beyond a perpendicular position while the tension inducing Hinge Pin 23 ensures that the Parabolic Plates 11, unable to swing freely, remain reliably in position for the loading operation.

What has been described and illustrated herein is an example embodiment of the invention along with some of its variations. The terms, descriptions and figures used herein are set forth by way of illustration only and are not meant as limitations. Those of ordinary skill in the art will recognize that many variations are possible within the spirit and scope of the invention in which all terms are meant in their broadest, reasonable sense unless otherwise indicated. Any headings utilized within the description are for convenience only and have no legal or limiting effect.

As will be understood by those of ordinary skill in the art, the disclosed embodiments may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the disclosed embodiments or its features may have different names, divisions and/or formats. Accordingly, the disclosure of the disclosed embodiments is intended to be illustrative, but not limiting, of the scope of the invention, which is set forth in the following claims.

What is claimed is:

1. An apparatus comprising:
a tensioned hinge;
a parabolic rung support coupled to the tensioned hinge; and
an upper mounting plate coupled to the tensioned hinge, the upper mounting plate including a fastening mechanism for mechanically attaching the apparatus to sliding or fixed members of a sliding ceiling ladder rack.

2. The apparatus of claim 1 wherein the parabolic rung support is configured with a parabolic or curved portion of a preferred operating dimension, the preferred operating dimension having a preferred radius of the curved portion ranging between 0.75 inches and 3 inches.

3. The apparatus of claim 1 wherein the parabolic rung support is configured to engage and support a rung of a multi-use ladder.

4. The apparatus of claim 1 wherein the parabolic rung support is configured to fold toward a center of the sliding ceiling ladder rack for storage.

5. The apparatus of claim 1 wherein the tensioned hinge includes a rotation limiting element, which serves to prevent the parabolic plate from hinging open beyond 90 degrees parallel to the strut

6. The apparatus of claim 1 wherein the tensioned hinge includes a hinge pin configured to apply constant tension to a hinge point to eliminate free swinging of the parabolic rung support.

7. The apparatus of claim 1 wherein the fastening mechanism of the upper mounting plate is a plurality of holes to receive fasteners.

8. A system comprising:
a tensioned hinge;
a parabolic rung support coupled to the tensioned hinge;
an upper mounting plate coupled to the tensioned hinge; and
a sliding ceiling ladder rack, the upper mounting plate being mechanically attached to sliding or fixed members of the sliding ceiling ladder rack.

9. The system of claim 8 wherein the parabolic rung support is configured with a parabolic or curved portion of a preferred operating dimension, the preferred operating dimension having a preferred radius of the curved portion ranging between 0.75 inches and 3 inches.

10. The system of claim 8 wherein the parabolic rung support is configured to engage and support a rung of a multi-use ladder.

11. The system of claim 8 wherein the parabolic rung support is configured to fold toward a center of the sliding ceiling ladder rack for storage.

12. The system of claim 8 wherein the tensioned hinge includes a rotation limiting element, which serves to prevent the parabolic rung support from hinging open beyond 90 degrees parallel to the strut.

13. The system of claim 8 wherein the tensioned hinge includes a hinge pin configured to apply constant tension to a hinge point to eliminate free swinging of the parabolic rung support.

14. The system of claim 8 wherein the fastening mechanism of the upper mounting plate is a plurality of holes to receive fasteners.

15. A method comprising:
providing a tensioned hinge;
coupling a parabolic rung support to the tensioned hinge;
coupling an upper mounting plate coupled to the tensioned hinge; and
attaching the upper mounting plate to a sliding ceiling ladder rack, the upper mounting plate being mechanically attached to sliding or fixed members of the sliding ceiling ladder rack.

16. The method of claim 15 wherein the parabolic rung support is configured with a parabolic or curved portion of a preferred operating dimension, the preferred operating dimension having a preferred radius of the curved portion ranging between 0.75 inches and 3 inches.

17. The method of claim 15 wherein the parabolic rung support is configured to engage and support a rung of a multi-use ladder.

18. The method of claim 15 wherein the parabolic rung support is configured to fold toward a center of the sliding ceiling ladder rack for storage.

19. The method of claim 15 wherein the tensioned hinge includes a rotation limiting element, which serves to prevent the parabolic rung support from hinging open beyond 90 degrees parallel to the strut.

20. The method of claim 15 wherein the tensioned hinge includes a hinge pin configured to apply constant tension to a hinge point to eliminate free swinging of the parabolic rung support.
